(19) United States
(12) Patent Application Publication
(10) Pub. No.: US 2024/0367339 A1
(43) Pub. Date: Nov. 7, 2024

(54) TOOL FOR MAKING WOODEN STRAWS AND THE PROCESS OF PRODUCTION

(71) Applicants: Filip Golome, Mostar (BA); Hamza Smajlovic, Visoko (BA); Damjan Puljic, Capijina (BA)

(72) Inventors: Filip Golome, Mostar (BA); Hamza Smajlovic, Visoko (BA); Damjan Puljic, Capijina (BA); Luka Saravanja, Mostar (BA)

(73) Assignees: Filip Golome, Mostar (BA); Hamza Smajlovic, Visoko (BA); Damjan Puljic, Capijina (BA)

(21) Appl. No.: 18/683,276

(22) PCT Filed: Aug. 15, 2022
(86) PCT No.: PCT/BA2022/000004

§ 371 Date: Feb. 13, 2024

(30) Foreign Application Priority Data
Aug. 16, 2021 (BA) BAP213428A

(51) Int. Cl. B27M 3/24; B27H 1/00; B27M 3/08

(52) U.S. Cl. CPC B27M 3/24; B27M 3/08; B27H 1/00

(57) ABSTRACT

A new method of producing wooden straws from pure wood using a special set of tools and steps in the production. The procedure is carried out using a modified shaping and cutter machine, which is normally used for metal processing, by adding a special tool and cylinders. The wooden straw has multiple advantages compared to the previous state of the art, especially in relation to ecological advantages in preserving the health of people and the environment, since no glues or additives of any kind are used in the production process.

### CROSS REFERENCE TO RELATED APPLICATION

This application is a National Stage Entry of PCT/BA2022/000004 filed Aug. 15, 2022, under the International Convention and claiming priority over Bosnia and Herzegovina Patent Application No. BAP213428A filed Aug. 16, 2021.

### FIELD OF THE INVENTION

This invention relates to the production of wooden straws from healthy raw materials of trees that have fallen naturally or else. The procedure is carried out using a modified machine, which is normally used for metal processing, by adding a special tool and cylinders.

According to the international classification, the invention is classified as: B29C57/12, A61J15/00, A47G21/18.

### Technical Problem

The global problem of plastic pollution due to improper disposal and recycling has led to a great demand for alternative solutions. There is no economical production of ecologically acceptable wooden straws. Other alternative solutions have not proven to be quite effective due to their functionality or expensive production. Those examples are as follows:
The paper straw dissolves quickly in water and releases its composition, which is made of carcinogenic glue,
Paste straw dissolves quickly in water and therefore only for single and short use,
A metal straw is very expensive to manufacture and is not economical to use for one use,
Glass straw is fragile, expensive and difficult to maintain,
Straws made from wood, such as bamboo straws, require expensive production and it is not economical to use them once.

No alternative solution offers secure sustainability and environmental friendliness. The raw materials from which other solutions are obtained are not sustainable.

### STATE OF THE ART

The current state of alternative products and straw production with all its models shows several basic shortcomings:
a. Environmental unsustainability
b. Expensive production
c. Expensive product
d. Inability to be compatible for multiple and single uses
e. ingredients from impure supplements
f. Straws are fragile and brittle or bent
g. They do not have a natural texture
h. Long decomposition process, unsuitable for disposal in the priory
i. Difficulties in recycling
j. Rapid degradation in beverages

### SUMMARY OF THE INVENTION

This method involves the production of a wooden straw, whereby the straw produced by this method is perfectly functional for use in all drinks regardless of the temperature of drinks.

One of the novelties of the subject invention is that the straw itself as a final product in the production process does not have any adhesives, such as glue and additives of any kind.

Furthermore, the straw can last almost indefinitely in drinks. It can be even disinfected and reused, if required for any reason. At the same time it's cheap enough to be acceptable for single use. It provides a better experience of the beverage on which it is used due to the natural property of wood to absorb taste and smell, i.e. it improves the taste and aroma of the drink.

The required raw material must be healthy wood, but it can be used from trees that have fallen naturally.

The natural material gives a comfortable and natural feeling to hold and use/consume due to its pure wood texture.

### BRIEF DESCRIPTION OF THE DRAWINGS

Detailed reproductions of the subject invention are shown in the drawings, in which:

FIG. 1. Shows the working tool (exclusively for the shaping machine);

FIG. 2. Shows the straw bending/winding cylinder;

FIG. 3. Shows the appearance of the raw material and the final product—model 1;

FIG. 4. Shows the appearance of the raw material and the final product—model 2;

FIG. 5. Shows the appearance of the raw material and the final product—model 3;

FIG. 6. Shows the working tool (shaping machine and cutter machine/slitter) for models 1 and 3; and

FIG. 7. Shows the working tool-knife (shaping machine and cutter machine/cutter) for model 2.

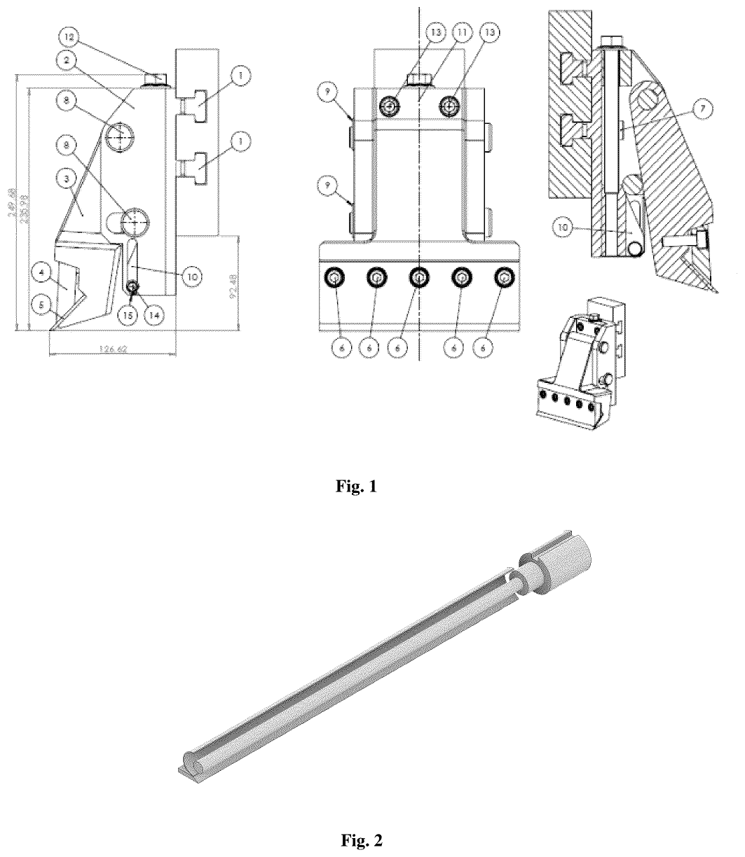

### DETAILED DESCRIPTION OF THE INVENTION

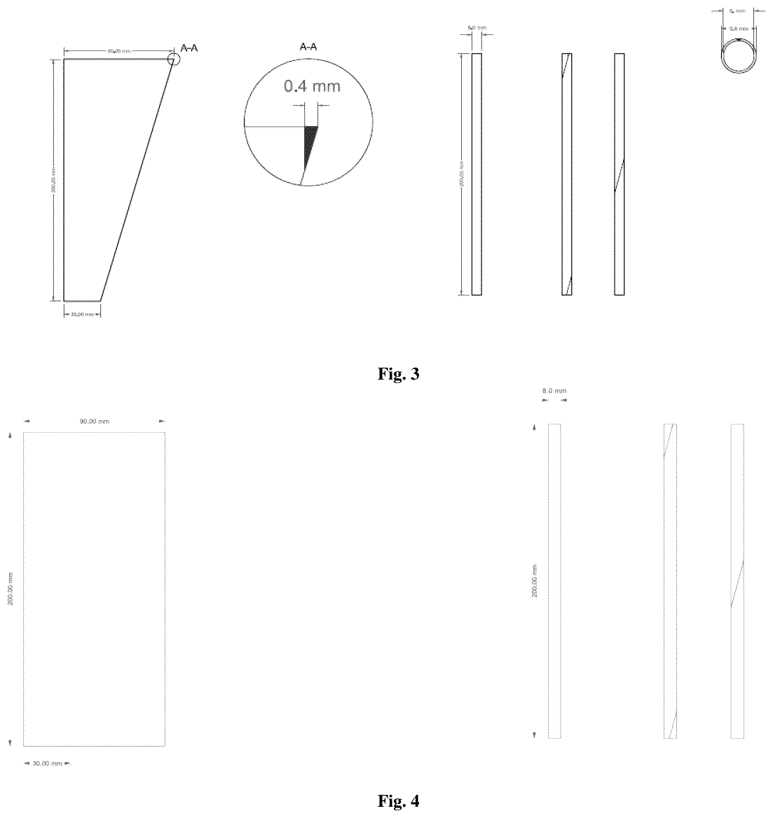

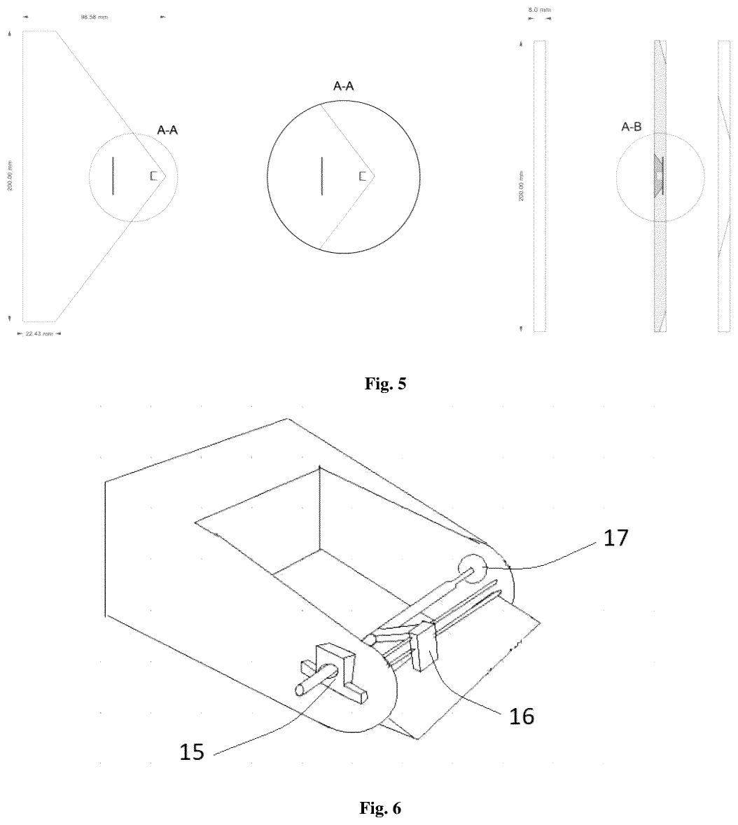

As for the process of production of straws, it is necessary to prepare the raw material in such a way as to obtain the shape of one of the three desired models of straws at will, both in relation to the dimensions and in relation to the choice of the raw material itself (FIG. 3, FIG. 4 and FIG. 5). Production of all three models of straws are clarified as below by the two machines:

1. Shaping machine (a machine that has a horizontal movement)—a machine that was used in the initial phase when experimenting and developing processing technology. The raw material is clamped with the help of a clamp. The main motion is performed by the tool while the workpiece is stationary. After the return stroke, the tool head is lowered by 0.01 mm-1 mm depending on the desired sheet thickness.

2. Cutter machine/cutter (a machine that has a vertical motion)—a machine that is currently used for reasons of more efficient parameters in serial production. The raw material is pressed with the help of a mechanical press. The main motion is performed by the tool, while the auxiliary motion is performed by the workpiece, which is stationary due to cutting. After the return stroke, the workpiece is moved by a step of 0.01 mm-1 mm depending on the desired thickness of the sheet.

The tool for making wooden straws is placed on the head of the machine (cutter or shaping machine) which has a straight line motion. There is a knife on the tool, placed in a vertical or horizontal position (cutter machine/cutter or shaping machine), in which way the raw material prepared in this way will be pressed better and keep the shape of the straw, which during the working stroke by the force of the machine's rectilinear movement scrapes/cuts at an angle to the surface a layer of raw material that is stationary, i.e. fixed with a clamp or a mechanical press.

With certain raw materials, a sheet of the required dimensions for bending a straw with a thickness of 0.01 mm-1 mm is obtained in the process of the working stroke, and a straw is obtained during the return process. With other raw materials, where only a knife is needed, without cylinders, a straw is obtained during the working stroke. For this cycle of obtaining straws, it takes about 1-2 seconds to complete. The shaping machine returns to its original position, the tool on the machine is automatically lowered by the given step, which in our case is the thickness of the sheet 0.01 mm-1 mm, and the second cutting cycle begins.

And with a cutting machine, the workpiece is moved by a step of 0.01 mm-1 mm depending on the desired thickness.

To prepare the first model, we prepare the raw material in the shape of a trapezoid (FIG. 3).

The height is 20-40 cm, the length of one side is 5-9 cm, and the other side is 3 cm. The dimensions are such that they would eventually represent the shape of the straw winding, where at the end of the winding process, a corner (triangle) remains on which the force of the teeth will act and press and keep the shape of the straw.

The tool for making wooden straws is placed on the machine head (cutter machine/cutter that has a vertical rectilinear motion or shaping machine that has a horizontal rectilinear motion). There is a knife on the tool, which during the working stroke, with the force of the machine's straight-line movement, scrapes/cuts at an angle the surface layer of the raw material, which is fixed with a clamp or a mechanical press.

A cylinder for rolling/shaping the straw is placed above the knife (FIG. 2).

Namely, a cylinder is a device consisting of two components: 1. a shaft that rotates in accordance with the rolling or scraping of the raw material, 2. open “U-shaped” pipe that serves as a limiter. The complete mechanism is placed above the knife on the tool with the shaft being fixed to the side of the machine or tool while the open tube is fixed above the knife on the tool itself.

In the process of the working stroke, a sheet of the required dimensions for bending a straw with a thickness of 0.01 mm-1 mm is obtained. At the moment of cutting wood, the machine pushes the sheet between two rollers located above the knife. The lower roller has a diameter of the appropriate dimensions required for the straw standard, diameter 6 mm, around which the cut sheet is wound. At one end of that roller there is a stepper motor that moves it through the bearing, and at the other end there is no support, like a console, because at that end the straw will fall out with the help of a lever, which will be explained in the following text. Also, at the end where there is no support, there is a hole (cone). The upper roller with a larger diameter, min. 2x larger than the lower one, it also drives a stepper motor via bearings. It serves to assist in pressing the sheet roll onto the lower roller. At its end there is a tooth, which at the moment when the sheet is wound and formed a straw around the lower roller, rotates synchronized with the lower roller and enters the hole of the lower roller and presses the straw, thus the tooth presses the upper surface layer of the angle (triangle shape) that remains coiled straws and it pushes the fibers through the other layers of coils and with that we get a straw that is attached and cannot be unwound.

In order for the cut sheet to go by winding around the roller, the sheet moves along the provided guides and partitions.

Further, in order to remove the straw from the lower roller, we use a handle that is also driven by a stepper motor and it is located above the rollers. The stepper motor, with synchronized operation, guides the handle with the help of the belt transmission on which it is located, and at the end of the cycle, the handle pushes the straw from the lower roller towards the part where there is no support. That part of the process takes place in the return stroke of the modified machine and one cycle of obtaining straws is completed. This cycle of obtaining straws takes approx. 3 seconds.

The machine returns to its original position, the tool on the machine is automatically lowered by the given step, which in our case is the thickness of the sheet 0.01 mm-1 mm, and the second cutting cycle begins.

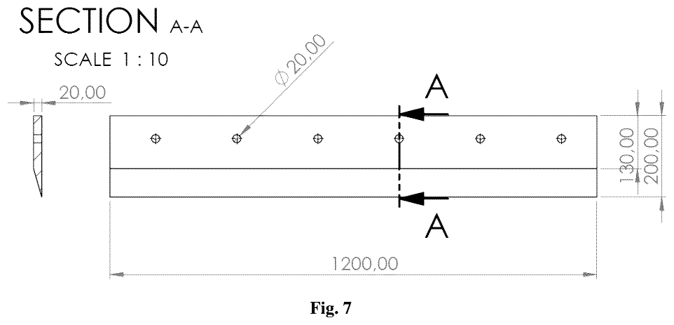

When making straw model 2 (FIG. 4), the straw is obtained without additional cylinders, that is, only with the help of vertical or horizontal movement of the knife shown (FIG. 7). During the action of the knife at an angle on the workpiece, the sheet rolls in on itself, which is why we get a functional straw as a result. Unlike the original tool, this one consists only of a knife and has a higher production efficiency. The speed of production with the cutting machine is significantly faster and more straws can be produced with one working stroke, while this is not the case with the shaping machine.

The length of the raw material is 5-40 cm, the width of the raw material is 2-10 cm. The straw made from this raw material has a diameter of 4-12 mm.

When making the model 3 straw, the only difference compared to the first model is the preparation of the resulting straw in case we want to achieve an extremely strong construction of the straw, and even greater longevity. In this case, two incisions are made on the finished product, i.e. the resulting straw, at the corner of the five-sided prism (FIG. 5) in the form of a vertical line and teeth (U-shaped). In this way, it is possible for the tooth to pass through the line (opening) and the straw is additionally locked in this way.

### LIST OF USED LABELS

1. T-piece “tool and machine connection”
2. Base case
3. Knife holder
4. Knife clamp
5. The knife
6. Screws for detachable connection
7. Angle adjustment bolt
8. Bolt connection of the knife holder and the base case
9. Revolving bolt
10. Bolt
11. Base line
12. Screw
13. Screw threads
14. Straw winding/shaping cylinder
15. Bearing
16. lever for ejecting the straw
17. the hole through which the final product/straw comes out

1. A tool for making a wooden straw comprising:
a T-piece connecting the tool;
a machine (1),
a base case (2),
a knife holder (3),
a knife clamp (4),
a knife (5),
screws for a detachable connection (6),
bolts for adjusting an angle (7),
bolts-connections for the knife holder,
a base case (8),
revolving bolts (9),
bolts (10),
screws (12),
threads for the screws (13), and
cylinders for the wooden straw rolling/shaping (14).

2. The tool for making wooden straws according to claim 1, wherein the knife (4) is attached to a predetermine position on the tool with pins, which enables an angle of the knife to be changed.

3. Tool for making wooden straws according to claim 1, wherein a length of the knife is determined by length of a desired wooden straw.

4. The tool for making wooden straws according to claim 1, wherein the cylinder (14) is placed above the knife (5) on the tool, with the shaft being fixed on a side of the tool while an open tube is fixed above the knife on the tool.

5. The tool for making wooden straws according to claim 1, wherein rollers fixed in front of the knife and are made of steel alloy to dimensions to the knife, wherein a diameter of a lower roller is 6 mm, and a diameter of an upper roller is at least two times larger, considering to the dimensions of the straw, wherein the lower roller has a recess, and on the upper roller there is a tooth, in which, by synchronized rotation, the tooth of the upper roller enters the hole of the lower roller and when a sheet of wood is found between two rollers that move in a circular motion, a pressure of the rollers on the wooden sheet creates a passage of fibers of an upper surface layer of a coil through a lower coils on the wooden straw so that the wooden straw cannot be unwound.

6. The tool for making wooden straws according to claim 1, wherein the clamp (4) is located on a work table and is positioned in front of the knife.

7. A tool for making wooden straws according to claim 1, wherein the knife is made of hardened steel alloy with dimensions of 1200 mm in length and 200 mm in height.

8. A process for producing a wooden straws comprising the steps of:
wrapping a leaf of wood to form a straw having a trapezoid shape, 20-40 cm wide, 5-9 cm long on one side, and 3 cm long on the other side, wherein wherein at the end of a winding process, a corner having a shape of a triangle remains on which the force of a cutting angle of a knife will act and press and hold the shape of the straw, in which a straw sheet with a height of 0.56 mm is obtained, a width—200 mm, a thickness of one side 50 mm-90 mm, a thickness of the other side—30 mm, and in which the wooden straw as a finished product has dimensions of a height—200 mm, an outer diameter—Ø8-Ø12 mm, an inner diameter—Ø4-Ø6 mm.

9. The process of production of wooden straws comprising the step of wrapping a raw material to obtain a shape of a regular four-sided prism, wherein a knife placed in a vertical position cuts the raw material and to obtain a wooden sheet with a width of 150 mm-400 mm; a height of 30 mm-50 mm, a thickness of 0.01 mm—1 mm, and in which the wooden straw is obtained as a finished product with dimensions of height—150 mm-400 mm, outer diameter of—Ø8 mm-Ø12 mm, an inner diameter of Ø4 mm-Ø6 mm.

10. The process of production of wooden straws comprising the steps of wrapping a leaf of wood to form a straw to obtain a shape of a trapezoid, with a height of 20-40 cm, width 20 cm, a thickness of one side of 7 cm, and an other side of 3 cm, wherein at the end of a winding process there remains a triangle on which a force of a teeth will act and press and hold the shape of the straw, in which a sheet for the straw is obtained, with a height dimensions of—0.56 mm, width—200 mm, a thickness of one side—70 mm, a thickness of the other side—30 mm, and in which the wooden straw as a finished product has dimensions of height of—200 mm, an outer diameter—Ø8 mm, an inner diameter—Ø6 mm, in which two slits are cut on a corner of the trapezoid in the form of a vertical line and a U-shaped tooth, in which the U-shaped tooth is pulled through the line (hole) in which the straw is additionally locked.
